(19) United States
(12) Patent Application Publication
(10) Pub. No.: US 2026/0135834 A1
(43) Pub. Date: May 14, 2026

(54) SOME/IP PROTOCOL-BASED PACKET TRANSMISSION METHOD

(71) Applicant: HON HAI PRECISION INDUSTRY CO., LTD., New Taipei City (TW)

(72) Inventors: Chunzhuang MIAO, New Taipei City (TW); Chih-Chieh SUN, New Taipei City (TW); Jun-Yu CHUANG, New Taipei City (TW)

(21) Appl. No.: 19/287,861

(22) Filed: Aug. 1, 2025

Related U.S. Application Data
(60) Provisional application No. 63/678,419, filed on Aug. 1, 2024.

(51) Int. Cl. H04L 45/74; H04L 61/5007

(52) U.S. Cl. CPC H04L 45/74; H04L 61/5007

(57) ABSTRACT

A SOME/IP protocol-based packet transmission method is disclosed. The method includes the following steps: encapsulating at least one signal, a sequence number, and a timestamp into a service data packet by a first electronic control unit; generating a checksum and adding the checksum to the service data packet; adding a communication identifier corresponding to the at least one signal to the service data packet; transmitting the service data packet to a second electronic control unit according to the SOME/IP protocol; in response to the second electronic control unit receiving the service data packet, verifying the sequence number, timestamp, verification code, and communication identifier to determine the integrity of the received service data packet.

### CROSS-REFERENCE TO RELATED APPLICATION

This application claims priority to U.S. Provisional Patent Application Ser. No. 63/678,419, filed Aug. 1, 2024, which is herein incorporated by reference in its entirety.

### BACKGROUND

### Technical Field

The present disclosure relates to a packet transmission method, and more particularly to a packet transmission method based on the SOME/IP protocol.

### Description of Related Art

With the increasing complexity of modern in-vehicle electronic systems, the demand for data exchange among electronic control units (ECUs) within a vehicle has significantly increased. In order to construct a highly modular and extensible in-vehicle system architecture, global automobile manufacturers and component suppliers have jointly established a standardized software platform referred to as Automotive Open System Architecture (AUTOSAR). This architecture facilitates the enhancement of development efficiency and system interoperability. Scalable Service-Oriented MiddlewarE over IP (SOME/IP) is one of the core communication protocols supported by AUTOSAR and can be configured to implement Service-Oriented Communication (SoC). The SOME/IP protocol operates over an Internet Protocol (IP) network, supports point-to-point and broadcast/multicast transmission, and allows ECUs to exchange data through service publication and subscription. Each service may include one or more methods and events, thereby flexibly fulfilling the data transmission requirements of different automotive applications.

AUTOSAR also promotes a design mechanism called “Signal to Service” (S2S), which encapsulates data originally transmitted as signals in a Controller Area Network (CAN) or Local Interconnect Network (LIN) into services defined by SOME/IP, enabling such signals to be transmitted as services in an Ethernet environment. This transformation improves the flexibility of data flow and the maintainability of the system. For example, a vehicle speed signal originally transmitted via CAN may be converted into a SOME/IP event. The event is provided by the sensor ECU acting as a server and subscribed to and received by Advanced Driver Assistance Systems (ADAS) or an In-Vehicle Infotainment System (IVI) acting as clients. This mechanism not only simplifies the integration between heterogeneous networks but also contributes to realizing the flexibility and reusability required by a Software-Defined Vehicle (SDV).

Furthermore, as in-vehicle communication systems evolve toward service-oriented and Ethernet-based architectures, the security of signal transmission becomes a primary consideration. If the packets exchanged among ECUs are lost, tampered with, or replayed, serious impacts on the vehicle control logic may occur, potentially endangering driving safety. Therefore, in order to ensure high data integrity and security for signal transmission under the SOME/IP architecture, establishing an effective packet verification and protection mechanism is a critical issue in this field.

### SUMMARY

The objective of the present disclosure is to provide a technical solution for verifying the integrity and correctness of transmitted service packets, thereby ensuring that the data is not lost, tampered with, or replayed during transmission.

To achieve the above objective, one aspect of the present disclosure provides a SOME/IP protocol-based packet transmission method adapted for use between a first electronic control unit and a second electronic control unit in an in-vehicle electronic system. The packet transmission method includes: encapsulating at least one signal, a sequence number, and a timestamp into a service data packet by the first electronic control unit; generating a checksum and adding the checksum to the service data packet; adding a communication identifier corresponding to the at least one signal to the service data packet; transmitting the service data packet to the second electronic control unit according to the SOME/IP protocol; in response to the second electronic control unit receiving the service data packet, verifying the sequence number, the timestamp, the checksum, and the communication identifier to determine the integrity of the received service data packet.

In some embodiments of the present disclosure, the step of verifying the sequence number, the timestamp, the checksum, and the communication identifier includes: in response to the second electronic control unit receiving the service data packet, verifying the communication identifier to determine whether a source of the at least one signal included in the service data packet is correct.

In some embodiments of the present disclosure, the step of verifying the sequence number, the timestamp, the checksum, and the communication identifier further includes: in response to the communication identifier being verified as incorrect, triggering an error management mechanism; discarding the received service data packet.

In some embodiments of the present disclosure, the error management mechanism includes: sending an error response to the first electronic control unit; logging a mismatch of the communication identifier in an error log.

In some embodiments of the present disclosure, the step of verifying the sequence number, the timestamp, the checksum, and the communication identifier further includes: in response to the communication identifier being verified as correct, verifying the checksum to determine whether data included in the service data packet is correct.

In some embodiments of the present disclosure, the step of verifying the sequence number, the timestamp, the checksum, and the communication identifier further includes: in response to the checksum being verified as correct, decapsulating the service data packet to extract the sequence number and the timestamp; verifying the extracted sequence number to determine whether a transmission order of the service data packet is correct; verifying the extracted timestamp to determine whether a transmission timing of the service data packet is correct.

In some embodiments of the present disclosure, the step of verifying the extracted sequence number to determine whether the transmission order of the service data packet is correct includes: by the second electronic control unit, comparing the extracted sequence number with a recorded sequence number stored in the second electronic control unit; in response to a first difference between the extracted sequence number and the recorded sequence number being equal to one, verifying that the transmission order of the service data packet is correct and updating the recorded sequence number to the extracted sequence number.

In some embodiments of the present disclosure, the step of verifying the extracted sequence number to determine whether the transmission order of the service data packet is correct further includes: in response to the first difference being less than one, verifying that the transmission order of the service data packet is incorrect and triggering an error management mechanism; discarding the received service data packet.

In some embodiments of the present disclosure, the error management mechanism includes: sending a packet retransmission request to the first electronic control unit; determining that the received service data packet is a duplicate packet and logging the occurrence of the duplicate packet in an error log.

In some embodiments of the present disclosure, the step of verifying the extracted sequence number to determine whether the transmission order of the service data packet is correct further includes: in response to the first difference being greater than one, verifying that the transmission order of the service data packet is incorrect and triggering an error management mechanism; discarding the received service data packet.

In some embodiments of the present disclosure, the error management mechanism includes: sending a packet retransmission request to the first electronic control unit; determining that a packet is lost prior to receiving the service data packet and logging the occurrence of the packet loss in an error log.

In some embodiments of the present disclosure, the step of verifying the extracted timestamp to determine whether the transmission timing of the service data packet is correct includes: obtaining a reception time when the second electronic control unit receives the service data packet; comparing a second difference between the extracted timestamp and the reception time with a predetermined threshold to verify whether the transmission timing of the service data packet is correct.

In some embodiments of the present disclosure, the step of verifying the extracted timestamp to determine whether the transmission timing of the service data packet is correct further includes: in response to the second difference being greater than the predetermined threshold, verifying that the transmission timing of the service data packet is incorrect and triggering an error management mechanism; discarding the received service data packet.

In some embodiments of the present disclosure, the error management mechanism includes: sending a packet retransmission request to the first electronic control unit; determining that the reception time of the service data packet is greater than a maximum delay time and logging the occurrence of the delay in an error log.

In some embodiments of the present disclosure, the step of verifying the extracted timestamp to determine whether the transmission timing of the service data packet is correct further includes: in response to the second difference being less than or equal to the predetermined threshold, by the second electronic control unit, comparing the extracted timestamp with a recorded timestamp stored in the second electronic control unit; in response to a third difference between the extracted timestamp and the recorded timestamp being within a time interval, verifying that the transmission timing of the service data packet is correct; updating the recorded timestamp to the extracted timestamp.

In some embodiments of the present disclosure, the step of verifying the extracted timestamp to determine whether the transmission timing of the service data packet is correct further includes: in response to the third difference not being within the time interval, verifying that the transmission timing of the service data packet is incorrect and triggering an error management mechanism; discarding the received service data packet.

In some embodiments of the present disclosure, the error management mechanism includes: sending a packet retransmission request to the first electronic control unit; determining occurrence of a replay attack based on a difference in a time interval of the extracted timestamp and logging the occurrence in an error log.

In some embodiments of the present disclosure, the step of generating the checksum and adding the checksum to the service data packet includes: applying a hash function to at least a portion of data in a payload of the service data packet to generate a first hash value as the checksum; adding the first hash value to the payload of the service data packet.

In some embodiments of the present disclosure, the step of verifying the sequence number, the timestamp, the checksum, and the communication identifier includes: by the second electronic control unit, applying the same hash function to at least a portion of the data in the payload of the received service data packet to generate a second hash value; determining whether the second hash value is identical to the first hash value; in response to the second hash value being identical to the first hash value, verifying that the checksum is correct.

In some embodiments of the present disclosure, the step of verifying the sequence number, the timestamp, the checksum, and the communication identifier further includes: in response to the second hash value being different from the first hash value, verifying that the checksum is incorrect and triggering an error management mechanism; discarding the received service data packet.

In some embodiments of the present disclosure, the error management mechanism includes: sending an error response to the first electronic control unit; logging a mismatch of the checksum in an error log.

In some embodiments of the present disclosure, the SOME/IP protocol-based packet transmission method further includes: after transmitting the service data packet to the second electronic control unit according to the SOME/IP protocol, updating the sequence number by the first electronic control unit to a value equal to the sequence number added to the transmitted service data packet plus one.

In summary, according to the packet transmission method proposed in the present disclosure, the sequence number, timestamp, checksum, and communication identifier are added to the service data packet to be transmitted at the transmitting end. These data are verified at the receiving end to determine whether various possible data errors (e.g., tampering, replay, loss, etc.) occur during transmission, thereby ensuring the integrity, correctness, and timing of the data. Furthermore, by providing and verifying the sequence number and timestamp, the transmitted packets can be tracked and synchronized. Moreover, corresponding error management mechanisms are proposed for various verification errors to ensure timely response and remediation in the event of data integrity issues.

### BRIEF DESCRIPTION OF THE DRAWINGS

The embodiments of the present disclosure may be understood from the following detailed description taken in conjunction with the accompanying drawings. It should be noted that the various features are not necessarily drawn to scale as practiced in the industry. In fact, for purposes of clarity of discussion, the dimensions of various features may be arbitrarily enlarged or reduced.

FIG. 1 is a schematic diagram of an in-vehicle electronic system based on the SOME/IP protocol according to an embodiment of the present disclosure.

FIG. 2 is a flowchart of a packet transmission method based on the SOME/IP protocol according to an embodiment of the present disclosure.

FIG. 3 is a flowchart illustrating the verification of the communication identifier according to the packet transmission method of FIG. 2.

FIG. 4 is a flowchart illustrating the verification of the checksum according to the packet transmission method of FIG. 2.

FIG. 5 is a flowchart illustrating the verification of the sequence number according to the packet transmission method of FIG. 2.

FIG. 6 is a flowchart illustrating verification of the timestamp according to the packet transmission method of FIG. 2.

### DETAILED DESCRIPTION

The present disclosure is described in detail through the following embodiments. It should be noted that the description of the embodiments of the present disclosure provided herein is merely for illustrative purposes, and is not intended to disclose all possible embodiments exhaustively, nor to limit the specific embodiments of the present disclosure. In addition, identical reference numerals used in the drawings and the specification, as far as possible, denote identical or similar elements.

It should be understood that, although terms such as “first” and “second” may be used herein to describe various features, such terms should not limit such features. These terms are merely used to distinguish one feature from another.

The terminology used herein is intended solely for describing particular embodiments, and is not intended to limit the scope of the claimed invention. Unless otherwise specified, the singular forms of “a” or “the” as used herein may also include the plural forms.

In the following description and claims, the term “coupled” and its derivatives may be used. In certain embodiments, “coupled” may refer to two or more components being in direct physical or electrical contact with each other, or not being in direct contact with each other. “Coupled” may also refer to two or more components cooperating or interacting with each other.

The processes and blocks in the flowcharts included in the specification illustrate the architecture, functionality, and operations that can be implemented by systems, methods, and computer software products according to embodiments of the present disclosure. In this regard, each block in the flowcharts or functional block diagrams may represent a module, a segment, or a portion of code that includes one or more executable instructions for implementing specific logical functions. Furthermore, each block in the functional block diagrams and/or flowcharts, as well as combinations of blocks, may essentially be implemented by a dedicated hardware system for performing the specified functions or operations, or by a combination of dedicated hardware and computer program instructions. These computer program instructions may also be stored in computer-readable media that enable a computer or other programmable data processing apparatus to operate in a specific manner, such that the instructions stored in the computer-readable media are sufficient to implement the functions or operations specified in the blocks of the flowcharts and/or functional block diagrams.

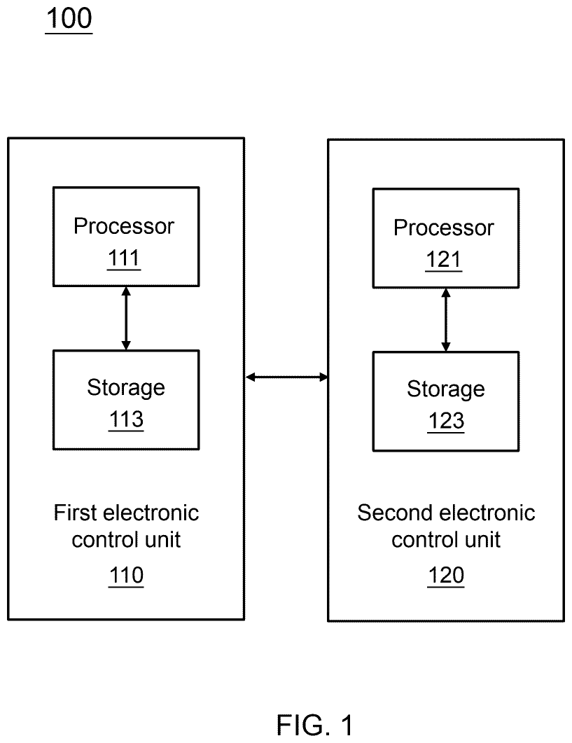

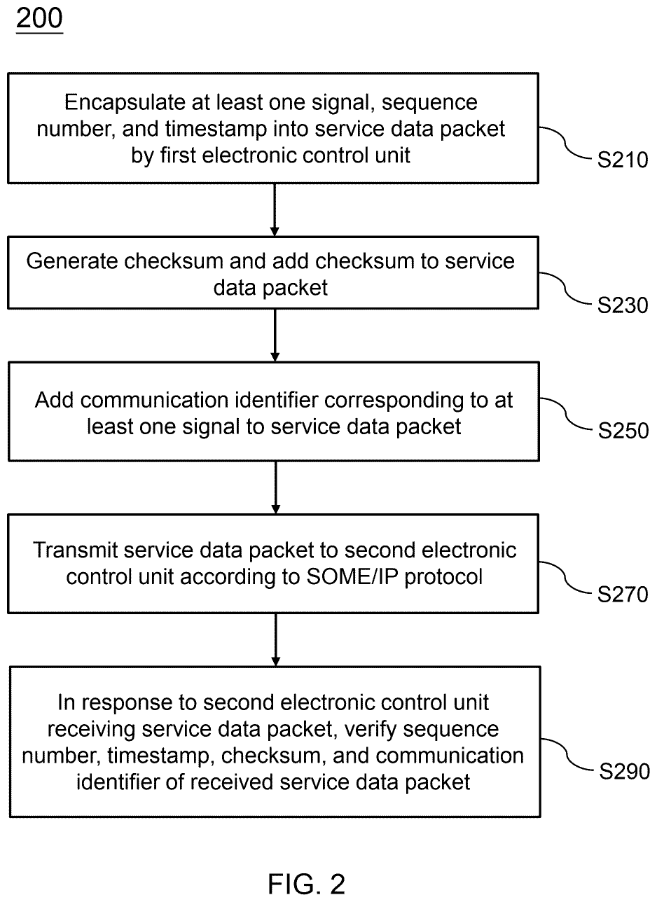

References are made to FIG. 1 and FIG. 2. FIG. 1 is a schematic diagram of an in-vehicle electronic system 100 based on the SOME/IP protocol according to an embodiment of the present disclosure. FIG. 2 is a flowchart of a packet transmission method 200 based on the SOME/IP protocol according to an embodiment of the present disclosure. The packet transmission method 200 may be performed, for example, within the in-vehicle electronic system 100. The in-vehicle electronic system 100 may include a first electronic control unit (ECU) 110 and a second electronic control unit 120. In this embodiment, the second electronic control unit 120 may function as a client (or a receiving end) to request or subscribe to at least one service from the first electronic control unit 110. Based on said request or based on the occurrence of an event corresponding to said at least one service, the first electronic control unit 110 may function as a server (or a transmitting end) to package signals received from other electronic control units (not shown) or signals provided by itself into service data packets, and then transmit them to the second electronic control unit 120. In other embodiments, the second electronic control unit 120 may also function as a service provider to offer services to other electronic control units. The first electronic control unit 110 may also function as a client to request or subscribe to at least one service from other electronic control units.

For ease of explanation of the following operational procedures, the in-vehicle electronic system 100 is shown with only two units, namely the first electronic control unit 110 and the second electronic control unit 120. The packet transmission method 200 may be performed between the first electronic control unit 110 and the second electronic control unit 120 to ensure the integrity and correctness of packet data during transmission. However, it should be understood by those skilled in the art that the in-vehicle electronic system 100 may include a number of electronic control units far greater than two, and that the packet transmission method 200 is applicable to any two or more electronic control units.

As shown in FIG. 1, the first electronic control unit 110 may include a processor 111 and a storage 113 electrically connected thereto. The storage 113 may store a plurality of instructions, various data, and codes, such that the processor 111, when executing the instructions, performs at least one step or module corresponding to the packet transmission method 200. The second electronic control unit 120 may include a processor 121 and a storage 123 electrically connected thereto. The storage 123 may store a plurality of instructions, various data, and codes, such that the processor 121, when executing the instructions, performs at least one step or module corresponding to the packet transmission method 200. In some embodiments, the storages 113 and 123 may include a programmable read-only memory (PROM), a read-only memory (ROM), an erasable programmable read-only memory (EPROM), an electrically-erasable programmable read-only memory (EEPROM), a one-time programmable read-only memory (OTPROM), a disk storage, a tape storage, or any other computer-readable storage medium capable of carrying or storing data. The processors 111 and 121 may include one or more central processing units (CPUs), microprocessors, digital signal processing chips, graphics processors, or a combination of various control chips.

In one embodiment, the first electronic control unit 110 may be, for example, a Zonal Controller (ZCU), which can be configured to integrate and manage sensors, actuators, and other electronic modules within a specific vehicle zone. Compared to a traditional architecture in which each functional module is independently equipped with an ECU, the ZCU adopts a zonal integration design, which can effectively reduce wiring length, lower cost and weight, and enhance system modularity and maintainability.

In one embodiment, the second electronic control unit 120 may be, for example, a High-Performance Computing Controller (HPC), which possesses high computing and data processing capabilities and typically serves as a central computing platform for the vehicle. It is responsible for integrating data from various zonal controllers or subsystems and executing complex decision-making and application algorithms. The HPC can communicate with the ZCU via Ethernet. The ZCU can package signals sensed by multiple sensors (e.g., indicator status, vehicle speed, door status) into SOME/IP service packets and transmit them to the HPC according to the SOME/IP protocol (the HPC may first subscribe to these services). The HPC can perform high-level computations based on this data, such as enabling the ADAS system to determine whether to apply automatic braking, or allowing the IVI system to display a dynamic interface based on vehicle speed. However, the present disclosure is not limited to these two types of electronic control units.

The following describes in detail the packet transmission method 200 performed between the first electronic control unit 110 and the second electronic control unit 120, which ensures the integrity and correctness of data during transmission. It should be noted that, in this example, prior to performing packet transmission, the second electronic control unit 120, functioning as a receiver or client, needs to send a service request (also referred to as a request-based service) or a subscription service (also referred to as an event-based service) to the first electronic control unit 110, which functions as a transmitter or server. The first electronic control unit 110 may passively transmit service data packets in response to the received request, or actively transmit service data packets to the second electronic control unit 120 in response to an event corresponding to the service being triggered.

In FIG. 2, first, in step S210, the first electronic control unit 110 encapsulates at least one signal, a sequence number, and a timestamp into a service data packet. Here, said at least one signal refers to data required by the second electronic control unit 120, which may be a signal generated by the first electronic control unit 110 itself, or a signal received by the first electronic control unit 110 from other electronic control units (e.g., sensors). In one embodiment, the sequence number is maintained and assigned by the first electronic control unit 110, acting as the transmitting end, and can be used to indicate the order of the transmitted service data packets. Details thereof will be described later.

In one embodiment, the software component (SWC) module of the first electronic control unit 110 can convert the signal into a SOME/IP service format via signal-to-service mapping, and then transmit the converted signal, sequence number, and timestamp to the runtime environment (RTE) module of the first electronic control unit 110 for encoding and encapsulating into a service data packet. The converted signal, sequence number, and timestamp may be placed within a payload of the service data packet.

Next, in step S230, a checksum is generated and added to the service data packet. In one embodiment, the RTE module may generate the checksum based on at least a portion of the data within the payload of the service data packet, so that the integrity of the data can be verified later. Once generated, the checksum may be placed within the payload of the service data packet.

In one embodiment, a hash function (e.g., SHA-256) may be used to compute at least a portion of the data within the payload of the service data packet to generate a hash value as the checksum. The hash value is then added to the payload of the service data packet. In another embodiment, the checksum may alternatively be a cyclic redundancy check (CRC), a message authentication code (MAC), or other verification codes.

Next, in step S250, a communication identifier (e.g., Communication ID) corresponding to at least one signal is added to the service data packet. In one embodiment, the service data packet containing the checksum may be translated by the communication stack (COM-stack) module of the first electronic control unit 110, which generates the header in accordance with the SOME/IP protocol. In this embodiment, the COM-stack module further adds the communication identifier to the header of the service data packet. The communication identifier may indicate the source of the signal, and may include, for example, a bus identifier, a Controller Area Network (CAN) identifier, or a Local Interconnect Network (LIN) identifier. In one embodiment, the communication identifier may be placed in the Message ID field of the header. The Message ID is 32 bits in length, with the first 16 bits used to set the Service ID. Accordingly, the communication identifier may be placed in the remaining 16 bits of the Message ID. For example, the bus identifier may be placed in bits 18 to 21, and the CAN identifier may be placed in bits 22 to 32; however, the present disclosure is not limited thereto.

Next, in step S270, the service data packet is transmitted to the second electronic control unit 120 according to the SOME/IP protocol. Once the service data packet has been converted into the SOME/IP format, it can be sent to the second electronic control unit 120 via the COM-stack module.

Next, in step S290, in response to the second electronic control unit 120 receiving the service data packet, the sequence number, timestamp, checksum, and communication identifier of the received service data packet are verified. Specifically, upon receiving the service data packet transmitted by the first electronic control unit 110, the second electronic control unit 120, acting as the receiving end, may verify the sequence number, timestamp, checksum, and communication identifier added according to the technical solutions of the present disclosure. This verification ensures that the data has not been lost, tampered with, or replayed during transmission, thereby confirming the integrity, correctness, and timeliness of the data.

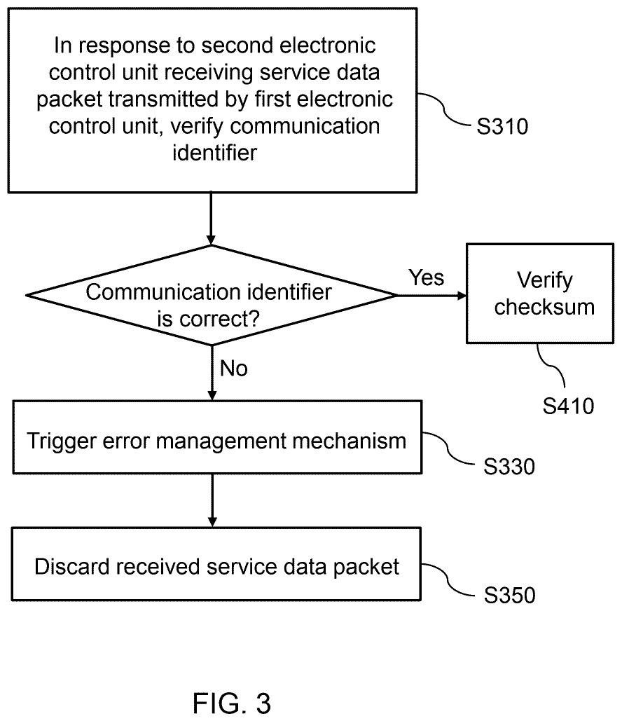

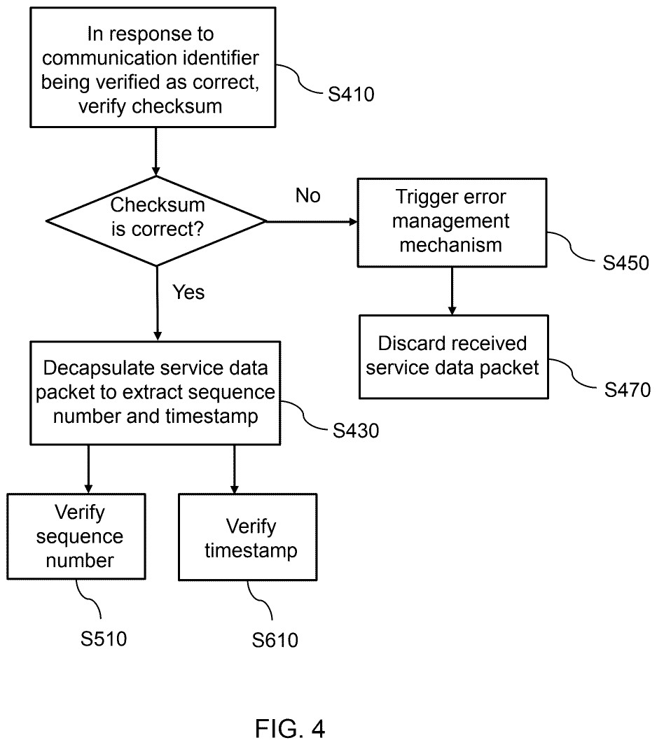

FIG. 3 is a flowchart illustrating the verification of the communication identifier according to the packet transmission method of FIG. 2. First, in step S310, in response to the second electronic control unit 120 receiving the service data packet transmitted by the first electronic control unit 110, the communication identifier is verified to determine whether the source of the at least one signal included in the service data packet is correct. If the verification fails, steps S330 and S350 are performed. If the verification succeeds, step S410 in FIG. 4 is performed to verify the checksum.

Specifically, when the second electronic control unit 120 requests a service or subscribes to a service from the first electronic control unit 110, it informs the first electronic control unit 110 of the sources of the required signals, as indicated by the communication identifier. Accordingly, when the COM-stack module of the second electronic control unit 120 receives the service data packet, it may compare the communication identifier placed in the header of the service data packet with the communication identifier originally used in the request or subscription. If the two match, the verification succeeds; if they differ, the verification fails. If the verification fails, step S330 is performed to trigger an error management mechanism. In one embodiment, the error management mechanism may include the following steps. An error response is sent to the first electronic control unit 110. Subsequently, the mismatch of the communication identifier is logged in an error log. Next, in step S350, the received service data packet is discarded by the second electronic control unit 120.

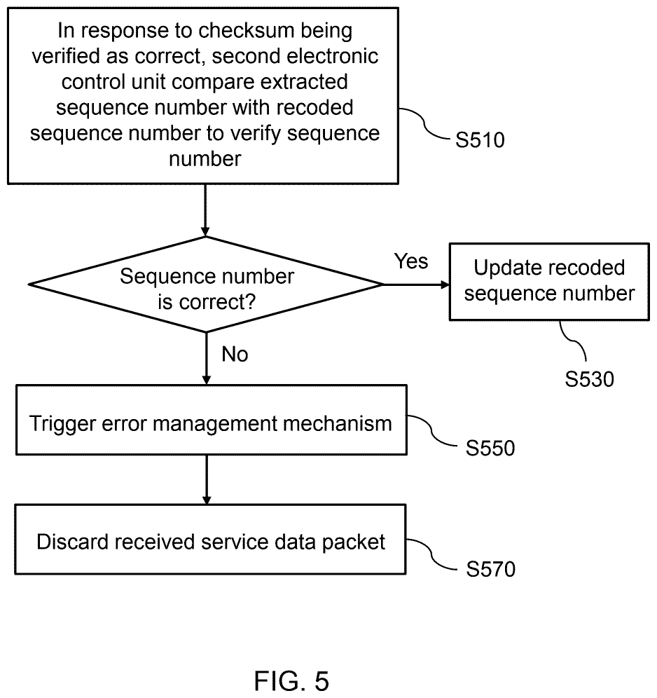

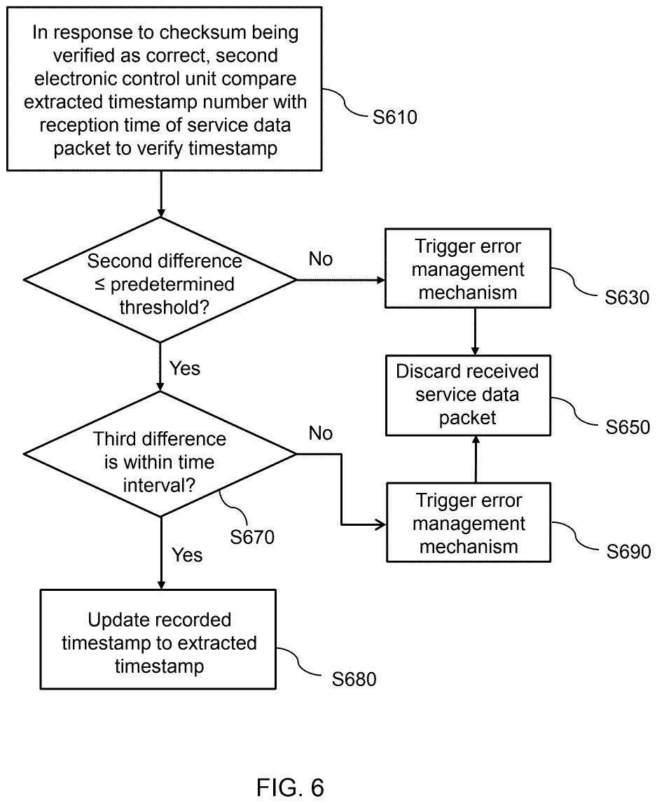

Reference is made to FIG. 4. FIG. 4 is a flowchart illustrating the verification of the checksum according to the packet transmission method 200 of FIG. 2. First, in step S410, the checksum is verified in response to the communication identifier being verified as correct. When the COM-stack of the second electronic control unit 120 determines that the communication identifier included in the service data packet is correct (i.e., the source of the requested signal is confirmed as correct), the service data packet may be transmitted to the RTE module of the second electronic control unit 120. The RTE module may verify the checksum included in the service data packet. In one embodiment, when the checksum is generated using a hash function, the RTE module of the second electronic control unit 120 may compute a local hash value by applying the same hash function (e.g., SHA-256) to the corresponding data of the received service data packet. The locally computed hash value may then be compared with the hash value included in the payload of the received service data packet. If the two match, the verification succeeds, then step S430 is performed to decode the service data packet for decapsulation, thereby extracting the sequence number and timestamp contained in the service data packet. Subsequently, step S510 of FIG. 5 is performed to verify the sequence number, and step S610 of FIG. 6 is performed to verify the timestamp.

If the hash value computed by the second electronic control unit 120 differs from the hash value included in the payload of the received service data packet, it indicates that the data is erroneous and may have been tampered with. In this case, the verification fails, and step S450 is performed to trigger an error management mechanism. In one embodiment, the error management mechanism may include the following steps. An error response is sent to the first electronic control unit 110; subsequently, the mismatch of the checksum is logged in the error log. Next, in step S470, the received service data packet is discarded by the second electronic control unit 120.

The above description illustrates the use of a hash value as the checksum. However, if a cyclic redundancy check or a message authentication code is used as the checksum, the verification process is similar to that of the hash value and will not be described herein in detail.

Reference is made to FIG. 5. FIG. 5 is a flowchart illustrating the verification of the sequence number according to the packet transmission method 200 of FIG. 2. First, in step S510, in response to the checksum being verified as correct, the second electronic control unit 120 compares the extracted sequence number with the recorded sequence number stored in the second electronic control unit 120 to verify the sequence number. If a first difference between the extracted sequence number and the recorded sequence number is equal to one, the transmission order of the service data packet is verified as correct, and step S530 is performed. If the first difference between the extracted sequence number and the recorded sequence number is not equal to one, the transmission order of the service data packet is verified as incorrect, and step S550 is performed to trigger an error management mechanism. Subsequently, in step S570, the second electronic control unit 120 discards the received service data packet.

Specifically, each time the second electronic control unit 120 receives a service data packet transmitted by the first electronic control unit 110, it records the sequence number included in the transmitted packet (provided that the verification of the communication identifier, checksum, and sequence number described above have all succeeded). In other words, the recorded sequence number is the sequence number added to the previous service data packet. Furthermore, each time the first electronic control unit 110 successfully transmits a service data packet to the second electronic control unit 120 (i.e., no error response or packet retransmission request is received), it updates a value of the sequence number to be provided in the next transmission, which is incremented by one from the sequence number added to the transmitted packet. The range of the sequence number can be defined by the first electronic control unit 110 acting as the transmitting end. For example, the sequence numbers may be defined from 0 to 255 by the first control unit 110. After each successful transmission, the sequence number is incremented by one. Accordingly, if the sequence number added to the current service data packet by the first electronic control unit 110 is 77, it indicates that the sequence number of the previously successfully transmitted service data packet is 76, which is recorded by the second electronic control unit 120. The second electronic control unit 120 then compares the extracted sequence number (77) with the recorded sequence number (76). If the difference between the two is 1, it indicates that the current service data packet sent by the first electronic control unit 110 is in the correct order, and thus the verification of the sequence number succeeds. Accordingly, step S530 is performed to update the recorded sequence number to the extracted sequence number. As a result, the second electronic control unit 120 updates the recorded sequence number (76) to the extracted sequence number (77). Similarly, if the first electronic control unit 110 does not receive any error response or packet retransmission request from the second electronic control unit 120, it updates the sequence number to be provided in the next transmission to the current added sequence number (77) plus 1, i.e., 78.

In addition, there are two cases where the first difference between the extracted sequence number and the recorded sequence number is not equal to one. The first difference may be either greater than one or less than one. In one embodiment, in response to the first difference being less than one, it indicates that the received service data packet is determined to be a duplicate packet (i.e., a packet that has been previously transmitted is retransmitted). Accordingly, the triggered error management mechanism may include the following steps. A packet retransmission request is sent to the first electronic control unit 110. Subsequently, the received service data packet is determined to be a duplicate packet, and the occurrence of the duplicate packet is logged in the error log.

In one embodiment, in response to the first difference being greater than one, it indicates that a packet is lost prior to receiving the current service data packet (i.e., a previously transmitted packet is not received) without being reported to the first electronic control unit 110. Accordingly, the triggered error management mechanism may include the following steps. A packet retransmission request is sent to the first electronic control unit 110. Subsequently, a determination is made as to that a packet is lost prior to receiving the service data packet, and the occurrence of the packet loss is logged in the error log.

Reference is made to FIG. 6. FIG. 6 is a flowchart illustrating verification of the timestamp according to the packet transmission method 200 of FIG. 2. First, in step S610, in response to the checksum being verified as correct, the second electronic control unit 120 compares the extracted timestamp with the reception time of the service data packet to verify the timestamp. In one embodiment, when the COM-stack module of the second electronic control unit 120 receives the service data packet transmitted by the first electronic control unit 110, it stores the reception time of the service data packet. A second difference between the reception time and the extracted timestamp is then compared to a predetermined threshold to determine whether the timestamp is correct. If the second difference is greater than the predetermined threshold, it indicates that the transmission timing of the service data packet is incorrect, and step S630 is performed to trigger an error management mechanism. Subsequently, in step S650, the second electronic control unit 120 discards the received service data packet.

Specifically, the predetermined threshold may be set as the maximum transmission delay time of the first electronic control unit 110 when transmitting the packet. Therefore, if the extracted timestamp (e.g., the time when the first electronic control unit 110 receives the request or is triggered by an event) differs from the reception time of the service data packet at the second electronic control unit 120 by more than the maximum transmission delay time of the first electronic control unit 110, it indicates that the received service data packet is not a response to the request or subscription, or that the received service data packet may have been tampered with. Accordingly, the triggered error management mechanism may include the following steps. A packet retransmission request is sent to the first electronic control unit 110. Subsequently, a determination is made as to that the reception time of the service data packet is greater than the maximum delay time, and the occurrence of the delay is logged in the error log.

In one embodiment, in response to the second difference being less than or equal to the predetermined threshold, step S670 is performed, in which the second electronic control unit 120 compares a third difference between the extracted timestamp and the recorded timestamp stored in the second electronic control unit 120 with a time interval to verify the correctness of the extracted timestamp. If the extracted timestamp is verified as correct, step S680 is performed. If the extracted timestamp is verified as incorrect, step S690 is performed to trigger an error management mechanism. Subsequently, in step S650, the second electronic control unit 120 discards the received service data packet.

Specifically, in addition to determining whether the reception time of the service data packet exceeds the maximum delay time, the second electronic control unit 120 may further determine whether the reception times of the service data packets are monotonically increasing. In the case where the second electronic control unit 120 subscribes to an event-based service, the first electronic control unit 110 periodically transmits the service to the second electronic control unit 120 at a fixed interval. In other words, the difference between the timestamps of adjacent service data packets received by the second electronic control unit 120 from the first electronic control unit 110 is not significant. Accordingly, each time the second electronic control unit 120 successfully receives a service data packet transmitted by the first electronic control unit 110, it records the extracted timestamp as the recorded timestamp. By comparing the third difference between the currently extracted timestamp and the previously recorded timestamp with the time interval (i.e., determining whether the third difference is within the time interval), it can determine whether the service data packet is transmitted according to the fixed periodic interval. If the third difference is within the time interval, it indicates that the current service data packet is still transmitted within the fixed period, and thus the extracted timestamp is verified as normal. Subsequently, step S680 is performed to update the recorded timestamp to the currently extracted timestamp.

If the third difference is not within the time interval, it indicates that the current service data packet is not transmitted within the fixed periodic interval. However, based on the determination of the delay time, the transmission timing of the current service data packet remains normal, which may indicate the occurrence of a replay attack. Accordingly, the extracted timestamp is verified as incorrect, and step S690 is performed. The triggered error management mechanism may include the following steps. A packet retransmission request is sent to the first electronic control unit 110. Subsequently, a determination is made as to the occurrence of a replay attack based on the discrepancy in the interval of the extracted timestamp, and the occurrence is logged in the error log.

In summary, according to the packet transmission method proposed in the present disclosure, the sequence number, timestamp, checksum, and communication identifier are added to the service data packet to be transmitted at the transmitting end. These data are verified at the receiving end to determine whether various possible data errors (e.g., tampering, replay, loss, etc.) occur during transmission, thereby ensuring the integrity, correctness, and timing of the data. Furthermore, by providing and verifying the sequence number and timestamp, the transmitted packets can be tracked and synchronized. Moreover, corresponding error management mechanisms are proposed for various verification errors to ensure timely response and remediation in the event of data integrity issues.

Although the present disclosure has been described in considerable detail with reference to certain embodiments thereof, the present disclosure is not limited thereto. It will be apparent to those skilled in the art that various modifications and variations can be made to the present disclosure without departing from the scope or spirit of the present disclosure. Therefore, the scope of the present disclosure shall be defined by the appended claims.

What is claimed is:

1. A SOME/IP protocol-based packet transmission method, adapted for use between a first electronic control unit and a second electronic control unit in an in-vehicle electronic system, the SOME/IP protocol-based packet transmission method comprising:
encapsulating at least one signal, a sequence number, and a timestamp into a service data packet by the first electronic control unit;
generating a checksum and adding the checksum to the service data packet;
adding a communication identifier corresponding to the at least one signal to the service data packet;
transmitting the service data packet to the second electronic control unit according to the SOME/IP protocol; and
in response to the second electronic control unit receiving the service data packet, verifying the sequence number, the timestamp, the checksum, and the communication identifier to determine an integrity of the received service data packet.

2. The SOME/IP protocol-based packet transmission method of claim 1, wherein the step of verifying the sequence number, the timestamp, the checksum, and the communication identifier comprises:
in response to the second electronic control unit receiving the service data packet, verifying the communication identifier to determine whether a source of the at least one signal included in the service data packet is correct.

3. The SOME/IP protocol-based packet transmission method of claim 2, wherein the step of verifying the sequence number, the timestamp, the checksum, and the communication identifier further comprises:
in response to the communication identifier being verified as incorrect, triggering an error management mechanism; and
discarding the received service data packet.

4. The SOME/IP protocol-based packet transmission method of claim 3, wherein the error management mechanism comprises:
sending an error response to the first electronic control unit; and
logging a mismatch of the communication identifier in an error log.

5. The SOME/IP protocol-based packet transmission method of claim 2, wherein the step of verifying the sequence number, the timestamp, the checksum, and the communication identifier further comprises:
in response to the communication identifier being verified as correct, verifying the checksum to determine whether data included in the service data packet is correct.

6. The SOME/IP protocol-based packet transmission method of claim 5, wherein the step of verifying the sequence number, the timestamp, the checksum, and the communication identifier further comprises:
in response to the checksum being verified as correct, decapsulating the service data packet to extract the sequence number and the timestamp;
verifying the extracted sequence number to determine whether a transmission order of the service data packet is correct; and
verifying the extracted timestamp to determine whether a transmission timing of the service data packet is correct.

7. The SOME/IP protocol-based packet transmission method of claim 6, wherein the step of verifying the extracted sequence number to determine whether the transmission order of the service data packet is correct comprises:
by the second electronic control unit, comparing the extracted sequence number with a recorded sequence number stored in the second electronic control unit; and
in response to a first difference between the extracted sequence number and the recorded sequence number being equal to one, verifying that the transmission order of the service data packet is correct and updating the recorded sequence number to the extracted sequence number.

8. The SOME/IP protocol-based packet transmission method of claim 7, wherein the step of verifying the extracted sequence number to determine whether the transmission order of the service data packet is correct further comprises:
in response to the first difference being less than one, verifying that the transmission order of the service data packet is incorrect and triggering an error management mechanism; and
discarding the received service data packet.

9. The SOME/IP protocol-based packet transmission method of claim 8, wherein the error management mechanism comprises:
sending a packet retransmission request to the first electronic control unit; and
determining that the received service data packet is a duplicate packet and logging an occurrence of the duplicate packet in an error log.

10. The SOME/IP protocol-based packet transmission method of claim 7, wherein the step of verifying the extracted sequence number to determine whether the transmission order of the service data packet is correct further comprises:
in response to the first difference being greater than one, verifying that the transmission order of the service data packet is incorrect and triggering an error management mechanism; and
discarding the received service data packet.

11. The SOME/IP protocol-based packet transmission method of claim 10, wherein the error management mechanism comprises:
sending a packet retransmission request to the first electronic control unit; and
determining that a packet is lost prior to receiving the service data packet and logging an occurrence of a loss of the packet in an error log.

12. The SOME/IP protocol-based packet transmission method of claim 6, wherein the step of verifying the extracted timestamp to determine whether the transmission timing of the service data packet is correct comprises:
obtaining a reception time when the second electronic control unit receives the service data packet; and
comparing a second difference between the extracted timestamp and the reception time with a predetermined threshold to verify whether the transmission timing of the service data packet is correct.

13. The SOME/IP protocol-based packet transmission method of claim 12, wherein the step of verifying the extracted timestamp to determine whether the transmission timing of the service data packet is correct further comprises:
in response to the second difference being greater than the predetermined threshold, verifying that the transmission timing of the service data packet is incorrect and triggering an error management mechanism; and
discarding the received service data packet.

14. The SOME/IP protocol-based packet transmission method of claim 13, wherein the error management mechanism comprises:
sending a packet retransmission request to the first electronic control unit; and
determining that the reception time of the service data packet is greater than a maximum delay time and logging an occurrence of a delay in an error log.

15. The SOME/IP protocol-based packet transmission method of claim 13, wherein the step of verifying the extracted timestamp to determine whether the transmission timing of the service data packet is correct further comprises:
in response to the second difference being less than or equal to the predetermined threshold, by the second electronic control unit, comparing the extracted timestamp with a recorded timestamp stored in the second electronic control unit;
in response to a third difference between the extracted timestamp and the recorded timestamp being within a time interval, verifying that the transmission timing of the service data packet is correct; and
updating the recorded timestamp to the extracted timestamp.

16. The SOME/IP protocol-based packet transmission method of claim 15, wherein the step of verifying the extracted timestamp to determine whether the transmission timing of the service data packet is correct further comprises:
in response to the third difference not being within the time interval, verifying that the transmission timing of the service data packet is incorrect and triggering an error management mechanism; and
discarding the received service data packet.

17. The SOME/IP protocol-based packet transmission method of claim 16, wherein the error management mechanism comprises:
sending a packet retransmission request to the first electronic control unit; and
determining an occurrence of a replay attack based on a difference in a time interval of the extracted timestamp and logging the occurrence in an error log.

18. The SOME/IP protocol-based packet transmission method of claim 1, wherein the step of generating the checksum and adding the checksum to the service data packet comprises:
applying a hash function to at least a portion of data in a payload of the service data packet to generate a first hash value as the checksum; and
adding the first hash value to the payload of the service data packet.

19. The SOME/IP protocol-based packet transmission method of claim 18, wherein the step of verifying the sequence number, the timestamp, the checksum, and the communication identifier comprises:
by the second electronic control unit, applying the same hash function to the at least a portion of the data in the payload of the received service data packet to generate a second hash value;
determining whether the second hash value is identical to the first hash value; and
in response to the second hash value being identical to the first hash value, verifying that the checksum is correct.

20. The SOME/IP protocol-based packet transmission method of claim 19, wherein the step of verifying the sequence number, the timestamp, the checksum, and the communication identifier further comprises:
in response to the second hash value being different from the first hash value, verifying that the checksum is incorrect and triggering an error management mechanism; and
discarding the received service data packet.

21. The SOME/IP protocol-based packet transmission method of claim 20, wherein the error management mechanism comprises:
sending an error response to the first electronic control unit; and
logging a mismatch of the checksum in an error log.

22. The SOME/IP protocol-based packet transmission method of claim 1, further comprising:
after transmitting the service data packet to the second electronic control unit according to the SOME/IP protocol, updating the sequence number by the first electronic control unit to a value equal to the sequence number added to the transmitted service data packet plus one.
